(19) United States
(12) Patent Application Publication
(10) Pub. No.: US 2015/0295815 A1
(43) Pub. Date: Oct. 15, 2015

(54) Autonomous System (AS) Policy-Adaptive Confederations with Selective Advertisement of AS Numbers to Non-Members

(71) Applicants: Alvaro E. Retana, Raleigh, NC (US); Pradosh Mohapatra, Fremont, CA (US)

(72) Inventors: Alvaro E. Retana, Raleigh, NC (US); Pradosh Mohapatra, Fremont, CA (US)

(73) Assignee: Cisco Technology, Inc., a corporation of California, San Jose, CA (US)

(21) Appl. No.: 14/251,799

(22) Filed: Apr. 14, 2014

(51) Int. Cl. H04L 12/721; H04L 12/751; H04L 29/06

(52) U.S. Cl. CPC H04L 45/26; H04L 69/24; H04L 45/02

(57) ABSTRACT

In one embodiment, an autonomous system (AS) policy-adaptive confederation selectively manipulates the ordered list of traversed AS's using AS's of members of the policy-adaptive confederation and/or the AS of the policy-adaptive confederation itself when advertising to routers of AS's outside the policy-adaptive confederation. In one embodiment, a first member router of a first autonomous system (AS) within a policy-adaptive confederation identified by a confederation AS receives from a second member router of a second AS within the policy-adaptive confederation a route advertisement for a first route associated with a first ordered AS list identifying one or more AS's within the policy-adaptive confederation. The first member advertises the first route associated with the first ordered AS list not including the confederation AS to a first external router external to the policy-adaptive confederation.

### TECHNICAL FIELD

The present disclosure relates generally to forwarding packets in a communications network.

### BACKGROUND

The communications industry is rapidly changing to adjust to emerging technologies and ever increasing customer demand. This customer demand for new applications and increased performance of existing applications is driving communications network and system providers to employ networks and systems having greater speed and capacity (e.g., greater bandwidth). In trying to achieve these goals, a common approach taken by many communications providers is to use packet switching technology.

The Border Gateway Protocol (BGP) is an inter-autonomous system routing protocol designed for Transmission Control Protocol/Internet Protocol (TCP/IP) networks. BGP requires that all BGP speakers within a single autonomous system (AS) be fully meshed. An autonomous system (AS) confederation is a collection of autonomous systems represented and advertised as a single AS number to BGP speakers that are not members of the local BGP confederation.

### BRIEF DESCRIPTION OF THE DRAWINGS

The appended claims set forth the features of one or more embodiments with particularity. The embodiment(s), together with its advantages, may be best understood from the following detailed description taken in conjunction with the accompanying drawings of which:

FIG. 5A illustrates a network operating according to one embodiment;

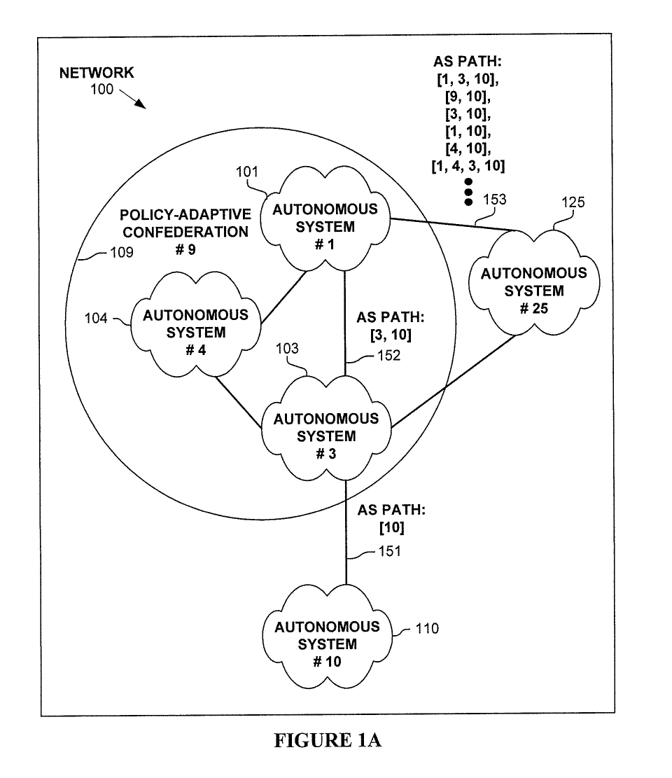

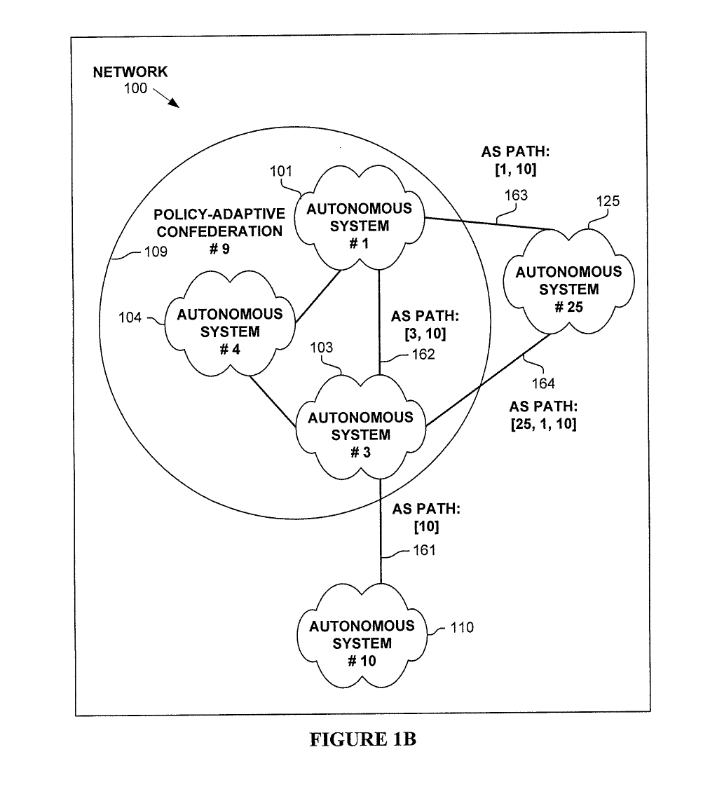

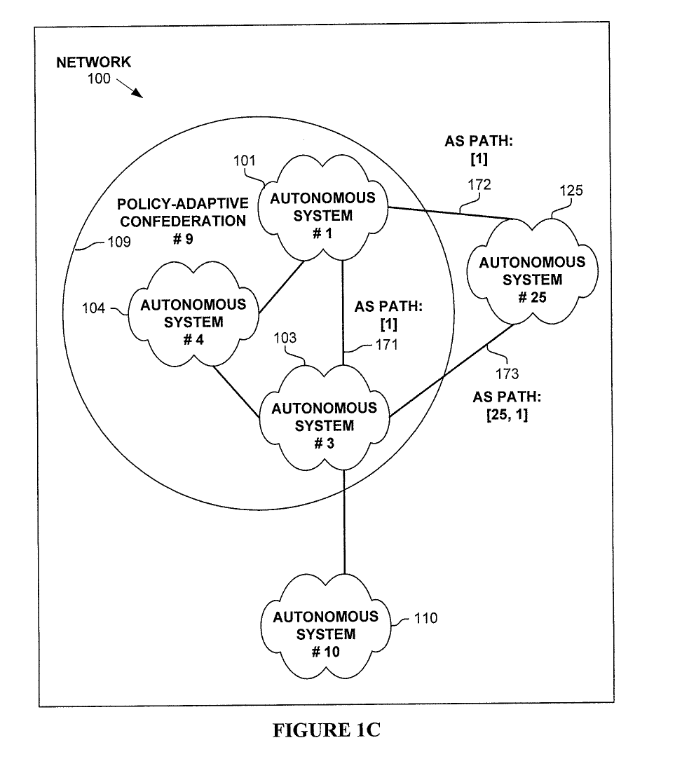

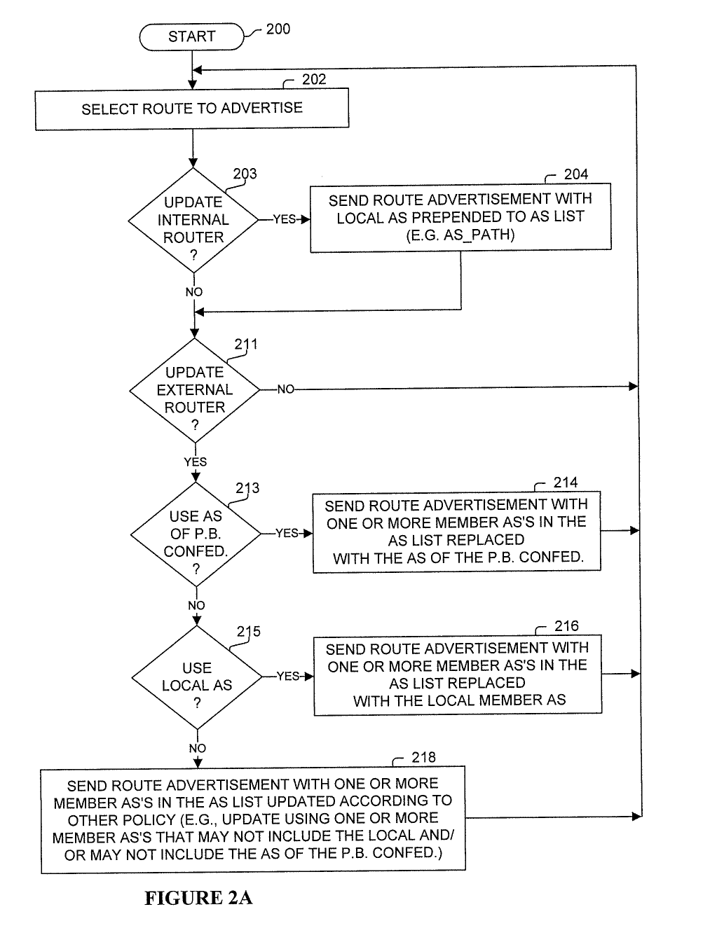

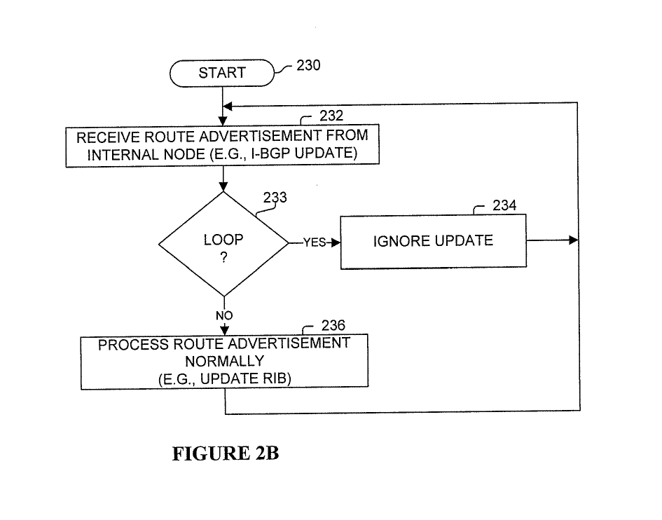

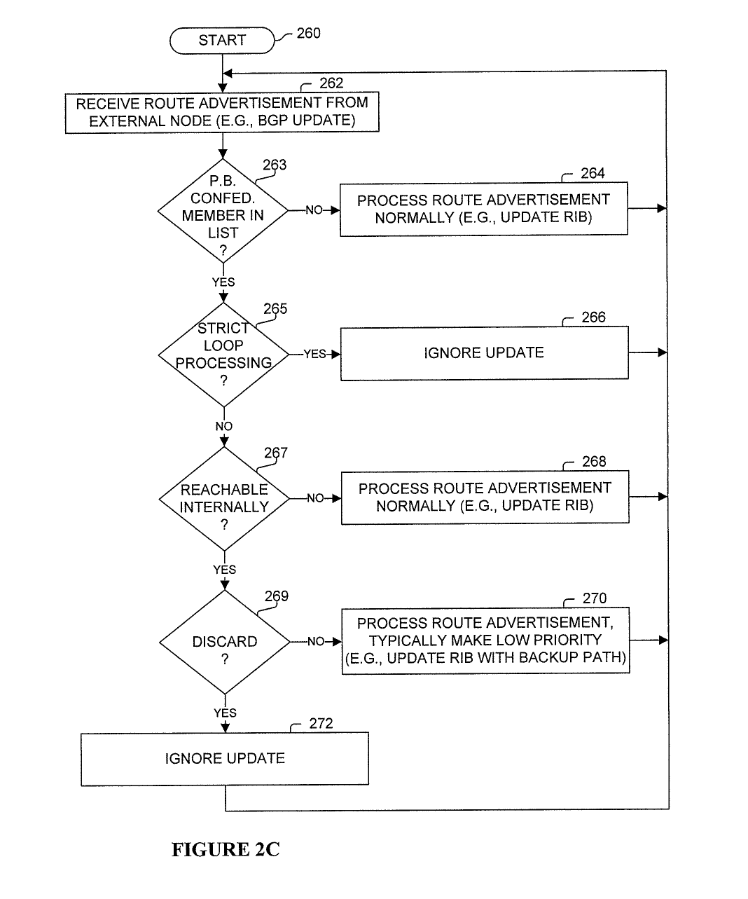

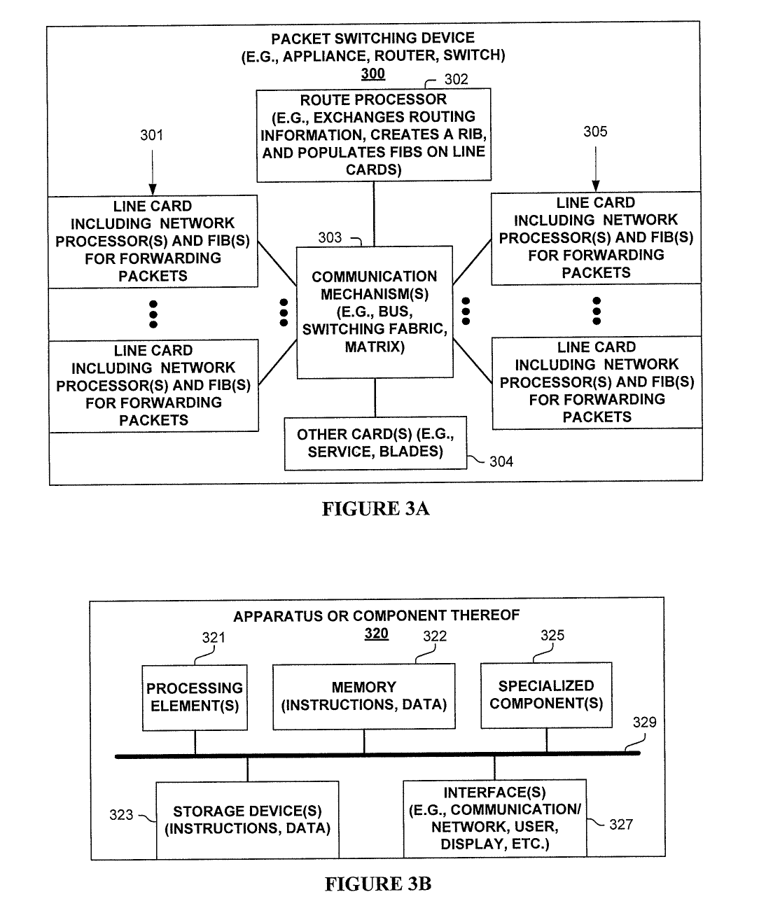

FIG. 1B illustrates a network operating according to one embodiment;

FIG. 1C illustrates a network operating according to one embodiment;

FIG. 2A illustrates a process according to one embodiment;

FIG. 2B illustrates a process according to one embodiment;

FIG. 2C illustrates a process according to one embodiment;

FIG. 3A illustrates a packet switching device (e.g., router) according to one embodiment; and

FIG. 3B illustrates an apparatus according to one embodiment

### DESCRIPTION OF EXAMPLE EMBODIMENTS

### 1. Overview

Disclosed are, inter alia, methods, apparatus, computer-storage media, mechanisms, and means associated with autonomous system (AS) policy-adaptive confederations with selective advertisement of AS numbers to non-members. One embodiment includes a method, comprising: receiving, by a first member router of a first autonomous system (AS) within a policy-adaptive confederation identified by a confederation AS, from a second member router of a second AS within the policy-adaptive confederation, a route advertisement for a first route associated with a first ordered AS list identifying one or more AS's within the policy-adaptive confederation; and advertising, by the first member to a first external router external to the policy-adaptive confederation, the first route associated with the first ordered AS list not including the confederation AS.

In one embodiment, the first ordered AS list said advertised includes said one or more AS's replaced with the first AS. In one embodiment, the first ordered AS list said advertised includes said one or more AS's replaced with an AS within the confederation AS which is not the first AS and wherein the first ordered AS list said advertised does not include the first AS. In one embodiment, the first ordered AS list said advertised includes said one or more AS's replaced with at least two different AS's of the confederation AS with none of which being the first AS, and wherein the first ordered AS list said advertised does not include the first AS. One embodiment includes performing loop verification based on the first ordered AS list received in the route advertisement.

### 2. Description

Disclosed are, inter alia, methods, apparatus, computer-storage media, mechanisms, and means associated with autonomous system (AS) policy-adaptive confederations with selective advertisement of AS numbers to non-members. Embodiments described herein include various elements and limitations, with no one element or limitation contemplated as being a critical element or limitation. Each of the claims individually recites an aspect of the embodiment in its entirety. Moreover, some embodiments described may include, but are not limited to, inter alia, systems, networks, integrated circuit chips, embedded processors, ASICs, methods, and computer-readable media containing instructions. One or multiple systems, devices, components, etc., may comprise one or more embodiments, which may include some elements or limitations of a claim being performed by the same or different systems, devices, components, etc. A processing element may be a general processor, task-specific processor, a core of one or more processors, or other co-located, resource-sharing implementation for performing the corresponding processing. The embodiments described hereinafter embody various aspects and configurations, with the figures illustrating exemplary and non-limiting configurations. Computer-readable media and means for performing methods and processing block operations (e.g., a processor and memory or other apparatus configured to perform such operations) are disclosed and are in keeping with the extensible scope of the embodiments. The term “apparatus” is used consistently herein with its common definition of an appliance or device.

The steps, connections, and processing of signals and information illustrated in the figures, including, but not limited to, any block and flow diagrams and message sequence charts, may typically be performed in the same or in a different serial or parallel ordering and/or by different components and/or processes, threads, etc., and/or over different connections and be combined with other functions in other embodiments, unless this disables the embodiment or a sequence is explicitly or implicitly required (e.g., for a sequence of read the value, process said read value—the value must be obtained prior to processing it, although some of the associated processing may be performed prior to, concurrently with, and/or after the read operation). Also, nothing described or referenced in this document is admitted as prior art to this application unless explicitly so stated.

The term “one embodiment” is used herein to reference a particular embodiment, wherein each reference to “one embodiment” may refer to a different embodiment, and the use of the term repeatedly herein in describing associated features, elements and/or limitations does not establish a cumulative set of associated features, elements and/or limitations that each and every embodiment must include, although an embodiment typically may include all these features, elements and/or limitations. In addition, the terms “first,” “second,” etc., are typically used herein to denote different units (e.g., a first element, a second element). The use of these terms herein does not necessarily connote an ordering such as one unit or event occurring or coming before another, but rather provides a mechanism to distinguish between particular units. Moreover, the phrases “based on x” and “in response to x” are used to indicate a minimum set of items “x” from which something is derived or caused, wherein “x” is extensible and does not necessarily describe a complete list of items on which the operation is performed, etc. Additionally, the phrase “coupled to” is used to indicate some level of direct or indirect connection between two elements or devices, with the coupling device or devices modifying or not modifying the coupled signal or communicated information. Moreover, the term “or” is used herein to identify a selection of one or more, including all, of the conjunctive items. Additionally, the transitional term “comprising,” which is synonymous with “including,” “containing,” or “characterized by,” is inclusive or open-ended and does not exclude additional, unrecited elements or method steps. Finally, the term “particular machine,” when recited in a method claim for performing steps, refers to a particular machine within the 35 USC §101 machine statutory class.

As used herein, policy-adaptive confederations refer to a group of autonomous systems that cooperate as an administrative entity, but deviate from the requirement of an autonomous system confederation per RFC 5065, “Autonomous System Confederations for BGP,” that requires advertising of the AS of the confederation (rather than just one or more AS's within the confederation) to routers external to the confederation. Policy-adaptive confederations allow traffic to be directed to different autonomous systems within the policy-adaptive confederations by manipulating the one or more AS's advertised for a route (which could be different than the AS of the advertiser), rather than simply directing traffic to any autonomous system within a confederation resulting from the advertising the AS of the confederation instead of autonomous systems within the confederation. In one embodiment, the selection of how to advertise the one or more AS's associated with a route is based on a selective granularity, such as, but not limited to, on a per prefix, peer, originating AS, or other basis. Further, policy-adaptive confederations are compatible with security procedures to detect and prevent spoofing. In one embodiment, the advertising of routes is similar to operations performed by a route server.

In one embodiment, a policy-adaptive confederation is formed by a group of autonomous systems that have a common parent relationship (e.g., from a business point of view) and that include the attributes of local policy implementation, regional identity separation, and consolidation of peering. In one embodiment, a router of an AS in a policy-adaptive confederation which can advertise any of those AS's in the ordered list of autonomous systems traversed by the route advertisement. One embodiment manipulates the AS_PATH using any of the autonomous system numbers/ASNs associated with the policy-adaptive confederation (e.g., ASNs of its member AS's, the ASN of the policy-adaptive confederation itself). This manipulation is typically performed to adjust how corresponding traffic is directed to AS's within the policy-adaptive confederation. The list of AS's may be lengthened to make a route less attractive, or decreased to make a route more attractive.

In one embodiment, it is not necessary for this idea to define a new AS_PATH segment type if each border router in the policy-adaptive confederation has specific knowledge of the other ASNs, and/or no replace actions are defined. However, a new segment type may be desirable to avoid misconfigurations at the edge. In one embodiment, a policy-adaptive confederation is referred to as a loose confederation (e.g., based on modification of a strict implementation of BGP confederations).

In one embodiment, a new AS_PATH segment type (called AS_LOOSE_CONFED_SEQUENCE) exists. The AS_LOOSE_CONFED_SEQUENCE defined as follows:
it is an ordered set of Member Autonomous Systems in the local loose confederation that the BGP UPDATE message (e.g., route advertisement) has traversed.
A BGP speaker receiving an AS_LOOSE_CONFED_SEQUENCE that contains its own ASN MUST treat the update as a loop.
When advertising a route to a member of the loose confederation (e.g., policy-adaptive confederation), the local BGP speaker MUST prepend it's ASN on to the AS_LOOSE_CONFED_SEQUENCE (if it exists), or create one.
   When advertising a route to a non-member of the loose confederation (e.g., policy-adaptive confederation), the local BGP speaker MUST remove the AS_LOOSE_CONFED_SEQUENCE from the AS_PATH.

In one embodiment, the same best path selection rules as with a strict confederation apply to loose confederations (e.g., policy-adaptive confederation). In one embodiment, there is an exception is that intra-loose-confederation advertisements of routes (e.g., those which contain the AS_LOOSE_CONFED_SEQUENCE segment) should prefer paths within the loose confederation over external routes. In one embodiment, a cost community is used to enforce any custom changes.

In one embodiment, when advertising a route to a peer external to the loose confederation, the BGP speaker has the option of adding to and/or replacing the ASNs associated with the loose confederation in the path with either the configured ASN or the specified local-AS. In one embodiment, an option is to add the ASN of the advertising router (default operation, equivalent to not using a loose confederation). In this case, the contents of the AS_{—} LOOSE_CONFED_SEQUENCE are copied (in order) into the corresponding AS_PATH segment, and the configured ASN (or specified local-as) is prepended. This option exposes the complete AS_PATH to external neighbors. In one embodiment, the contents of the AS_LOOSE_CONFED_SEQUENCE are discarded and the configured ASN (or specified local-AS) is prepended to the AS_PATH (if it exists, or one is created). This option hides the internal ASNs of the loose confederation and may result in effectively reducing the total AS_PATH length. In one embodiment, optionally the policy may choose to prepend the configured ASN (or local-AS) the same number of times as ASNs are included in the AS_LOOSE_CONFED_SEQUENCE to maintain at least the AS_PATH lengths (and not affect the traffic flows). In one embodiment, the replacement may use the ASN of the loose confederation. In one embodiment, the option also exists to use other ASNs associated with the loose confederation, including the configured ASN or a specified local-AS. In one embodiment, if local-AS is used, then all the current options remain valid.

FIG. 1A illustrates a network 100 operating according to one embodiment. Shown are five autonomous systems, AS-1 (101), AS-3 (103), AS-4 (104), AS-10 (110), and AS-25 (125). An autonomous system includes one or more routers (e.g., packet switching devices). Also shown is policy-adaptive confederation AS-9 (109) which includes the three autonomous systems AS-1 (101), AS-3 (103), and AS-4 (104).

FIG. 1A also illustrates the operation of one embodiment in which autonomous system-10 (110) advertises a route to autonomous system-3 (103) with the associated list of autonomous systems of the advertisement denoted by [10] (151). In other words, the advertisement was originated by autonomous system-10 (110). Autonomous system-3 (103) advertises this route to autonomous system-1 (101) with the associated list of autonomous systems of the advertisement denoted by [3, 10] (152).

Routers within autonomous systems AS-1 (101), AS-3 (103), and AS-4 (104) within policy-adaptive confederation AS-9 (109) have flexibility in manipulating the list of AS paths (e.g., AS_PATH). Some examples of the associated list of autonomous systems advertised with the route include, but are not limited to, [1, 3, 10], [9, 10], [3, 10], [1, 10], [4, 10], [1, 4, 3, 10] (denoted by 153). These advertisements include advertising router within AS-1 (101) to include its own AS, the AS of policy-adaptive confederation AS-9 (109), and/or one or more AS's (101, 103, 104) within policy-adaptive confederation AS-9 (109). The policy-selected advertisement of associated AS's determines how traffic will be forwarded by routes to autonomous system 10 (110) through routers of autonomous systems AS-1 (101), AS-3 (103), and AS-4 (104) within policy-adaptive confederation AS-9 (109).

For example, in diversely located autonomous systems, the administrative entity for policy-adaptive confederation AS-9 (109) may desire traffic going to autonomous system 10 from external sources to be delivered by the external sources to autonomous system 3 directly, rather than to any of autonomous systems AS-1 (101), AS-3 (103), and AS-4 (104) within policy-adaptive confederation AS-9 (109), which would require policy-adaptive confederation AS-9 (109) to transport the traffic through its network to AS-3 (103).

FIG. 1B is used to illustrate the policy-based advertisement of a route according to one embodiment. As shown, autonomous system-10 (110) advertises a route to autonomous system-3 (103) with the associated list of autonomous systems of the advertisement denoted by [10] (161). Autonomous system-3 (103) advertises this route to autonomous system-1 (101) with the associated list of autonomous systems of the advertisement denoted by [3, 10] (162). Autonomous system, based on a selected policy, advertises the route to autonomous-system 25 (125) with the associated list of autonomous systems of the advertisement denoted by [1, 10] (163). According to the selected policy, the router of autonomous system-1 (101) replaced all AS's of policy-adaptive confederation AS-9 (109) with its own AS (e.g., 1). Autonomous system-25 (125) advertises this route to autonomous system-3 (103) with the associated list of autonomous systems of the advertisement denoted by [25, 1, 10] (164). In one embodiment, loop detection is performed on this received route based on whether the route is within policy-adaptive confederation 109, such as, but not limited to that described in relation to FIG. 2C. As one can readily understand from FIG. 1B, this advertisement is a loop that must be detected, even though the advertised AS's in the ordered list of AS's does not include the AS of autonomous system-3 (103) nor the AS of policy-adaptive confederation AS-9 (109) of which autonomous system-3 (103) is a member. In one embodiment, the advertisement of this route will be dropped because of the detection of the loop.

FIG. 1C is used to illustrate the policy-based advertisement of a route according to one embodiment. As shown, autonomous system-1 (101) advertises a route of its own to both: autonomous system-3 (103) with the associated list of autonomous systems of the advertisement denoted by [1] (171), and based on a selected policy to autonomous system-25 (125) with the associated list of autonomous systems of the advertisement denoted by [1] (172). Autonomous system-25 (125) advertises this route to autonomous system-3 (103) with the associated list of autonomous systems of the advertisement denoted by [25, 1] (173). In one embodiment, loop detection is performed on this received route based on whether the route is within policy-adaptive confederation 109, such as, but not limited to that described in relation to FIG. 2C. In one embodiment, the advertisement of this route is dropped because it is an advertisement of a route within policy-adaptive confederation 109. In one embodiment, the advertisement of this route is installed as a backup path (e.g., made a low priority) because it is an advertisement of a route within policy-adaptive confederation 109 and the route is already reachable with policy-adaptive confederation 109. In one embodiment, the advertisement of this route is dropped as because it is an advertisement of a route within policy-adaptive confederation 109 and the route is already reachable with policy-adaptive confederation 109. In one embodiment, the advertisement of this route would be installed if the route is not reachable with policy-adaptive confederation 109.

FIG. 2A illustrates a process performed in one embodiment by a router with an autonomous system within a policy-adaptive confederation. In one embodiment, the selection of the policy on how to advertise the one or more AS's associated with a route is based on a selective granularity, such as, but not limited to, on a per prefix, peer, originating AS, or other basis. Also, multiple Border Gateway Protocol (BGP) sessions might need to be established between routers for advertising that comes from different first AS's in ordered list of AS's (e.g., AS_PATH).

Processing of the flow diagram of FIG. 2A begins with process block 200. In process block 202, a route to advertise is selected (e.g., from the routing information base/RIB).

As determined in process block 203, if the route should be advertised by the router to one or more other autonomous systems within the policy-adaptive confederation, then a route advertisement is sent with the local member AS prepended to the ordered list of traversed autonomous systems (e.g., the associated AS_PATH is updated). Processing continues to process block 211.

As determined in process block 211, if the route should be advertised by the router to one or more other autonomous systems outside the policy-adaptive confederation, then processing continues to process block 213; otherwise processing returns to process block 202.

As determined in process block 213, if only the AS number of the policy-adaptive confederation should be used as replacement data according to the selected policy, then in process block 214, the route is advertised with one or more policy-adaptive confederation member AS's replaced with the AS of the policy-adaptive confederation. Processing returns to process block 202.

Otherwise, as determined in process block 215, if only the AS number of the local member advertising this route should be used as replacement data according to the selected policy, then in process block 216 (otherwise processing proceeds to process block 218), the route is advertised with one or more policy-adaptive confederation member AS's replaced with the AS of this advertising router. Processing returns to process block 202.

Otherwise, as determined in process block 215 by default, the generalized policy manipulation of the ordered list of traversed AS's is performed in process block 218. This manipulation can include, but is not limited to, deleting AS's of the policy-adaptive confederation, and/or adding or replacing AS's of the policy-adaptive confederation with AS's of the policy-adaptive confederation itself or any member AS of the policy-adaptive confederation (e.g., including using one or more AS's different than that of the advertising router). Processing returns to process block 202.

FIG. 2B illustrates a process performed in one embodiment by a router within an autonomous system of the policy-adaptive confederation receiving a route advertisement from a router in another autonomous system of the policy-adaptive confederation. Processing begins with process block 230. In process block 232, the router receives a route advertisement from a router of another autonomous system of the policy-adaptive confederation (e.g., via internal BGP/i-BGP). As determined in process block 233, if a loop is detected (e.g., the AS of the receiving router is in the ordered list of traversed AS's), then in process block 234, the route advertisement is ignored; otherwise the route update is processed normally in process block 236 (e.g., a routing information base/RIB is updated). Processing returns to process block 232.

FIG. 2C illustrates a process performed in one embodiment by a router within an autonomous system of the policy-adaptive confederation receiving a route advertisement from a router in another autonomous system that is not in the policy-adaptive confederation. Processing begins with process block 260. In process block 262, the route advertisement is received from a router in another autonomous system that is not in the policy-adaptive confederation by a router in an autonomous system that is in the policy-adaptive confederation. One embodiment performs a more complex loop detection process than in a standard BGP confederation due to the manipulation of the advertised autonomous system numbers in one embodiment, such as that illustrated in relation to FIGS. 1A-B, and/or elsewhere.

As determined in process block 263, if an autonomous system related to the policy-adaptive confederation (e.g., one of the AS's of a member AS or the policy-adaptive confederation itself) is not in the ordered list of autonomous systems associated with the route advertisement, then in process block 264, the route update is processed normally (e.g., a routing information base/RIB is updated). Processing returns to process block 262.

Otherwise, as determined in process block 265, if the router is following a strict loop prevention policy, then in process block 266, the route update is ignored as it contained an AS related to the policy-adaptive confederation. Processing returns to process block 262.

Otherwise, as determined in process block 267, if an AS related to the policy-adaptive confederation is not reachable while staying within AS of the policy-adaptive confederation, then in process block 268, the route update is processed normally (e.g., a routing information base/RIB is updated). Processing returns to process block 262.

Otherwise, a policy determination is made in process block 269 to decide whether to ignore the route update in process block 272, or to process the route update making it low-priority/a backup route (e.g., by correspondingly updating a routing information base/RIB) in process block 270. Processing returns to process block 262.

One embodiment of a packet switching device 300 (e.g., network node) is illustrated in FIG. 3A. As shown, packet switching device 300 includes multiple line cards 301 and 305, each with one or more network interfaces for sending and receiving packets over communications links (e.g., possibly part of a link aggregation group), and with one or more processing elements that are used in one embodiment associated with autonomous system (AS) policy-adaptive confederations with selective advertisement of AS numbers to non-members. Packet switching device 300 also has a control plane with one or more processing elements 302 for managing the control plane and/or control plane processing of packets associated with autonomous system (AS) policy-adaptive confederations with selective advertisement of AS numbers to non-members. Packet switching device 300 also includes other cards 304 (e.g., service cards, blades) which include processing elements that are used in one embodiment to process packets associated with autonomous system (AS) policy-adaptive confederations with selective advertisement of AS numbers to non-members, and some communication mechanism 303 (e.g., bus, switching fabric, matrix) for allowing its different entities 301, 302, 304 and 305 to communicate.

Line cards 301 and 305 typically perform the actions of being both an ingress and egress line card, in regards to multiple other particular packets and/or packet streams being received by, or sent from, packet switching device 300. In one embodiment, line cards 301 and/or 305 perform operations associated with autonomous system (AS) policy-adaptive confederations with selective advertisement of AS numbers to non-members.

FIG. 3B is a block diagram of an apparatus 320 used in one embodiment associated with autonomous system (AS) policy-adaptive confederations with selective advertisement of AS numbers to non-members. In one embodiment, apparatus 320 performs one or more processes (which may include synchronization processing), or portions thereof, corresponding to one of the flow diagrams illustrated or otherwise described herein, and/or illustrated in another diagram or otherwise described herein.

In one embodiment, apparatus 320 includes one or more processing element(s) 321, memory 322, storage device(s) 323, specialized component(s) 325 (e.g. optimized hardware such as for performing lookup and/or packet processing operations, etc.), and interface(s) 327 for communicating information (e.g., sending and receiving packets, user-interfaces, displaying information, etc.), which are typically communicatively coupled via one or more communications mechanisms 329, with the communications paths typically tailored to meet the needs of a particular application.

Various embodiments of apparatus 320 may include more or fewer elements. The operation of apparatus 320 is typically controlled by processing element(s) 321 using memory 322 and storage device(s) 323 to perform one or more tasks or processes. Memory 322 is one type of computer-readable/computer-storage medium, and typically comprises random access memory (RAM), read only memory (ROM), flash memory, integrated circuits, and/or other memory components. Memory 322 typically stores computer-executable instructions to be executed by processing element(s) 321 and/or data which is manipulated by processing element(s) 321 for implementing functionality in accordance with an embodiment. Storage device(s) 323 are another type of computer-readable medium, and typically comprise solid state storage media, disk drives, diskettes, networked services, tape drives, and other storage devices. Storage device(s) 323 typically store computer-executable instructions to be executed by processing element(s) 321 and/or data which is manipulated by processing element(s) 321 for implementing functionality in accordance with an embodiment.

In view of the many possible embodiments to which the principles of the disclosure may be applied, it will be appreciated that the embodiments and aspects thereof described herein with respect to the drawings/figures are only illustrative and should not be taken as limiting the scope of the disclosure. For example, and as would be apparent to one skilled in the art, many of the process block operations can be re-ordered to be performed before, after, or substantially concurrent with other operations. Also, many different forms of data structures could be used in various embodiments. The disclosure as described herein contemplates all such embodiments as may come within the scope of the following claims and equivalents thereof.

What is claimed is:

1. A method, comprising:
receiving, by a first member router of a first autonomous system (AS) within a policy-adaptive confederation identified by a confederation AS, from a second member router of a second AS within the policy-adaptive confederation, a route advertisement for a first route associated with a first ordered AS list identifying one or more AS's within the policy-adaptive confederation; and
advertising, by the first member to a first external router external to the policy-adaptive confederation, the first route associated with the first ordered AS list not including the confederation AS.

2. The method of claim 1, comprising:
receiving, by the first member router, from the second member router, a second route advertisement for a second route associated with a second ordered AS list identifying one or more AS's of the policy-adaptive confederation; and
advertising, by the first member to the first external router, the second route associated with the second ordered AS list with said one or more AS's replaced with the confederation AS.

3. The method of claim 1, comprising advertising, by the first member to a second external router external to the policy-adaptive confederation, the first route associated with the first ordered AS list with said one or more AS's replaced with the confederation AS.

4. The method of claim 1, comprising advertising, by the first member to a second external router external to the policy-adaptive confederation, the first route associated with the first ordered AS list with said one or more AS's replaced with the first AS.

5. The method of claim 1, comprising advertising, by the first member to a second external router external to the policy-adaptive confederation, the first route associated with the first ordered AS list with said one or more AS's replaced with an AS within the confederation AS which is not the first AS and wherein the first ordered AS list said advertised to the second external router does not include the first AS.

6. The method of claim 1, comprising advertising, by the first member to a second external router external to the policy-adaptive confederation, the first route associated with the first ordered AS list with said one or more AS's replaced with at least two different AS's of the confederation AS with none of which being the first AS, and wherein the first ordered AS list said advertised to the second external router does not include the first AS.

7. The method of claim 1, wherein the first ordered AS list said advertised includes said one or more AS's replaced with the first AS.

8. The method of claim 1, wherein the first ordered AS list said advertised includes said one or more AS's replaced with an AS within the confederation AS which is not the first AS and wherein the first ordered AS list said advertised does not include the first AS.

9. The method of claim 1, wherein the first ordered AS list said advertised includes said one or more AS's replaced with at least two different AS's of the confederation AS with none of which being the first AS, and wherein the first ordered AS list said advertised does not include the first AS.

10. The method of claim 1, comprising: performing loop verification based on the first ordered AS list received in the route advertisement.

11. The method of claim 1, comprising:
receiving, by the first member router from an external router external to the policy-adaptive confederation, an external route advertisement for a particular route;
performing, by the first member router, for the particular route loop verification dependent on whether the particular route is determined to be within the policy-adaptive confederation.

12. A router, comprising:
one or more processing elements;
memory;
a plurality of interfaces configured for sending and receiving packets; and
one or more packet switching mechanisms configured to packet switch packets among said interfaces;
wherein said one or more processing elements are configured to perform operations, including:
policy adjusting, based on a selected policy from a plurality of policies, a first ordered autonomous system (AS) list, including one or more AS's within a policy-adaptive confederation of a first route advertisement received by the router and communicated between AS's in a policy-adaptive confederation identified by a confederation AS, for advertising to an external router external to the policy-adaptive confederation; and
initiating said advertisement of the first route with said policy-adjusted first ordered AS list to the external router;
wherein the plurality of policies include: replacing said one or more AS's with the AS of the first router, and replacing said one or more AS's with the AS of the policy-adaptive confederation.

13. The router of claim 12, wherein the plurality of policies further includes replacing said one or more AS's with an AS within the policy-adaptive confederation which is not the AS of the router.

14. The router of claim 13, wherein the plurality of policies further includes replacing said one or more AS's with at least two different AS's within the policy-adaptive with none of said at least two different AS's being the AS of the router.

15. The router of claim 12, wherein the router is configured to pick the selected policy from the plurality of policies based on a per-prefix, peer, and originating AS, individual or combination, basis.

16. The router of claim 12, comprising means for performing loop verification based on an advertisement received from an advertising external router external to the policy-adaptive confederation.

17. A method, comprising:
receiving, by a first member router of a first autonomous system (AS) within a policy-adaptive confederation identified by a confederation AS, from a second member router of a second AS within the policy-adaptive confederation, a route advertisement for a first route associated with a first ordered AS list identifying one or more AS's within the policy-adaptive confederation;
policy adjusting, based on a selected policy from a plurality of policies, the first ordered autonomous system (AS) list for advertising to an external router external to the policy-adaptive confederation, wherein the plurality of policies include: replacing said one or more AS's with the AS of the first router, and replacing said one or more AS's with the AS of the policy-adaptive confederation; and
sending said advertisement of the first route with said policy-adjusted first ordered AS list to the external router.

18. The method of claim 17, wherein the plurality of policies further includes replacing said one or more AS's with an AS within the policy-adaptive confederation which is not the AS of the router.

19. The method of claim 18, wherein the plurality of policies further includes replacing said one or more AS's with at least two different AS's within the policy-adaptive with none of said at least two different AS's being the AS of the router.

20. The method of claim 17, wherein the router is configured to pick the selected policy from the plurality of policies based on a per-prefix, peer, and originating AS, individual or combination, basis.
